(19) United States
(12) Patent Application Publication
(10) Pub. No.: US 2024/0280217 A1
(43) Pub. Date: Aug. 22, 2024

(54) HYDROGEN LINER

(71) Applicant: SAERTEX multiCom GmbH, Saerbeck (DE)

(72) Inventor: Nils Füchtjohann, Greven (DE)

(21) Appl. No.: 18/444,181

(22) Filed: Feb. 16, 2024

(30) Foreign Application Priority Data
Feb. 17, 2023 (EP) 23157333.8

(51) Int. Cl. F17C 1/02

(52) U.S. Cl. CPC F17C 1/02; F17C 2203/0604; F17C 2203/0619; F17C 2203/0663; F17C 2221/012

(57) ABSTRACT

A process for rehabilitating hydrogen lines or converting a line to the transport of hydrogen and a use of a liner for rehabilitating hydrogen lines or for converting a line to the transport of hydrogen. The liner includes at least one fibrous layer impregnated with a resin system. The liner includes a hydrogen barrier layer including at least one material selected from the group consisting of a polymer, metal, oxide, nitride, carbide, graphene, and a mixture thereof.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### FIELD

The invention relates to a process for rehabilitating hydrogen lines or converting a line to the transport of hydrogen and the use of a liner for rehabilitating hydrogen lines or for converting a line to the transport of hydrogen.

### BACKGROUND

Until now, it has been difficult to rehabilitate hydrogen lines without trenches. Technologies for constructing even longer hydrogen lines have already existed. However, until now these hydrogen lines had to be excavated for repair or replacement. Unlike wastewater or fresh water, the gas hydrogen has very specific requirements on the tightness of the lines since oxyhydrogen gas is formed from hydrogen escaping from lines and oxygen from the atmosphere and deflagrations and explosions can result. Therefore, until now there exists the prejudice that liners and particularly CIPP products and pull-in liners originally intended for the rehabilitation of wastewater or fresh water canals are not suited for the rehabilitation of hydrogen lines.

### SUMMARY

Accordingly, it is the object of the present invention to provide a technology that allows a trenchless rehabilitation of hydrogen lines such as long hydrogen pipelines, for instance, with excavations located at larger distances from each other, for example.

### DETAILED DESCRIPTION

In a first embodiment, this object is achieved by the use of a liner for rehabilitating a hydrogen line or for converting a line (such as lines for liquids or gases such as water or CO₂, for example) to the transport of hydrogen, wherein the liner comprises at least one fibrous layer impregnated with a resin system.

In another embodiment, the object of the invention is achieved by a process for rehabilitating hydrogen pipes or converting pipes (such as lines for liquids or gases such as water or CO₂, for example) to the transport of hydrogen, characterised in that a liner is inserted into a pipe (the hydrogen line or the line to be converted, for example) and then cured, wherein the liner comprises at least one fibrous layer impregnated with a resin system.

This has been particularly surprising for the person skilled in the art since even steel lines seemed not to be suitable to be used permanently as hydrogen lines. For the first time, the lines obtained according to the invention can permanently prevent the diffusion of hydrogen.

The following preferred embodiments pertain both the use and the process unless the process or the use is explicitly mentioned.

For example, a hydrogen line within the meaning of the invention is a line through which a gas or a gas mixture containing at least 50% by volume, particularly preferably at least 60% by volume, more preferably at least 90% by volume and in particular 100% by volume of gaseous hydrogen is passed. A hydrogen line within the meaning of the invention is a line, for example, and in particular a pipeline.

Preferably, the liner is used for the rehabilitation of energy source lines in which hydrogen is transported or to be transported. For this purpose also lines for other liquids and gases, such as water or CO₂, can be converted by the liner, for example. Energy source lines pose particular challenges since they are often operated under very high pressure. Preferably, the liner is used for the rehabilitation of hydrogen pipelines (in particular those having a length from at least 2 km to 10,000 km). For this, excavations can be dug at greater distances such as in a range from 50 to 500 m, for example. Especially longer hydrogen pipelines allow a much easier trenchless rehabilitation with the liner. The diameter of the hydrogen line is preferably in a range from 80 to 3000 mm. Preferably, the liner is used for the rehabilitation of hydrogen pipelines made of steel or for the conversion of other existing lines (lines for water or CO₂, for example) to the transport of hydrogen. Preferably, the wall thickness of the hydrogen line to be rehabilitated is in a range from 2 to 50 mm. When an existing line for a gas or a liquid is converted to the transport of hydrogen, the wall thickness can also be in a range from 2 to 500 mm. Preferably, the liner is used in hydrogen lines to be rehabilitated or in other lines converted to the transport of hydrogen using the liner, said lines being operated with a pressure exceeding 1 bar and particularly preferably with a pressure of at least 2 bar after the rehabilitation or conversion. The pressure can preferably be in a range from 1.01 to 120 bar. Preferably, the liner is used in hydrogen lines to be rehabilitated or in other lines converted to the transport of hydrogen using the liner, said lines being operated with an operating pressure (difference to the external pressure) exceeding 20 mbar after the rehabilitation or conversion. The operating pressure can preferably be in a range from 1.002 to 120 bar.

Within the meaning of the invention, a liner is a product for rehabilitating lines, for example, and particularly preferably not a product for sealing hydrogen tanks. Hydrogen tanks have completely different requirements on the properties of wall linings than lines since no material flow passes through them in the same manner as through lines.

Within the meaning of the invention, “trenchless” or “without trenches” means that it is not necessary to excavate the line completely but that it can remain buried to a large extent. With longer lines it may well be necessary to dig an excavation every 50 or 100 metres, for example, to have access to the line.

### Liner Structure

Preferably, the liner is tubular. The liner is preferably a pull-in liner. The liner may be a CIPP (cured in place product), for example.

Preferably, the liner comprises
a. at least one fibrous layer impregnated with a resin system and
b. at least one hydrogen barrier layer,
wherein the hydrogen barrier layer is suitable for reducing the diffusion of hydrogen through the hydrogen barrier layer and wherein the hydrogen barrier layer comprises at least one material selected from a polymer, metal, oxide, nitride, carbide, graphene and/or mixtures thereof. It may also be the case that the fibrous layer impregnated with the resin system already decreases the diffusion of hydrogen.

The liner or the fibrous layer may be uncured or cured.

The liner is preferably a pull-in liner. However, the liner may also be invertible.

Preferably, the permeability through the liner is in a range from 10⁻⁵ to 10⁻¹¹ mol H₂ (m·s·MPa)⁻¹ at room temperature and under normal ambient pressure. The permeability can be measured according to the description in the article World Electr. Veh. J. 2021, 12, 130.

In the cured state, the wall thickness of the liner (that is, all layers of the cured liner together) preferably has a thickness in a range from 2 to 120 mm. The upper limit may preferably also be 30 mm. The diameter of the cured liner is preferably in a range from 80 to 3000 mm. The ratio of the diameter to the wall thickness of the cured liner is preferably in a range from 25:1 to 200:1, particularly preferably in a range from 50:1 to 150:1.

In context with the above-mentioned inversion process it should be noted that the structure of the liner prior to installation obviously differs between the inversion process and the pull-in process. After installation in the pipe, the sequence of layers of a liner for the pull-in process remains unchanged. Obviously, the sequence of layers of an inversion liner after installation is the reverse of the sequence of layers prior to installation. Since it is the same liner, both variants are encompassed by this invention.

The hydrogen barrier layer does not have a longitudinal seam, for example. It would be very difficult to seal a longitudinal seam so that hydrogen cannot penetrate the longitudinal seam. For example, the hydrogen barrier layer may have at least one seam or at least one adhesively bonded overlapping area. Alternatively, the hydrogen barrier layer may also be seamless.

The single layers may comprise one or also several layers or material sheets. These layers (particularly the hydrogen barrier layer) or material sheets are connected to one another over the entire surface, for example.

The liner according to the invention may comprise additional layers.

Preferably, an anchor layer is arranged between the hydrogen barrier layer and the fibrous layer.

Preferably, at least the hydrogen barrier layer and the anchor layer are interconnected in a non-positive or positive-fit manner. Since at least these layers are preferably interconnected in a non-positive or positive-fit manner, they cannot move relative to each other. This substantially improves the stability of the complete layer structure. Moreover, the preferably internal hydrogen barrier layer is substantially strengthened by the anchor layer connected therewith, preventing the preferably internal hydrogen barrier layer from being damaged easily.

The anchor layer that preferably consists of a thermoplastic material has again preferably a thickness in a range from 10 to 5000 μm, particularly from 30 to 1000 μm and very particularly preferably from 40 to 500 μm. Preferably, the weight per unit area of the anchor layer may be in a range from 50 to 250 g/m², very particularly preferably in a range from 100 to 200 g/m². The anchor layer advantageously consists of a textile such as a nonwoven fabric or a melt adhesive or a combination of these variants. Very particularly preferably, the textile such as the nonwoven fabric (preferably mainly) contains glass (such as glass fibres), thermoplastic materials, PAN, natural fibres (such as flax or hemp, for example) or mixtures thereof. The thermoplastic materials are selected from polyurethane, polyethylene, polypropylene or polyester, for example. The melt adhesive contains a polyamide, polyethylene, APAO (amorphous polyolefin), EVAC (ethylene-vinyl acetate copolymer), TPE-E (polyester elastomer), TPE-U (polyurethane elastomer), TPE-A (copolyamide elastomer) or a vinylpyrrolidone/vinyl acetate copolymer and mixtures thereof, for example.

The liner according to the invention may comprise an exterior layer. Said layer is preferably arranged on the side of the liner facing the inner wall of the rehabilitated hydrogen line.

The exterior layer preferably has a thickness in a range from 40 to 2000 μm, more preferably a thickness in a range from 100 to 1500 μm, very particularly preferably a thickness in a range from 150 to 800 μm. Advantageously, the exterior layer is impermeable to UV radiation to prevent the resin in the fibre tube layer from curing during storage or transport, for example. For example, the exterior layer may consist of a polymer or also of a textile such as a polymer with a laminated nonwoven fabric, for example (such as a film with a laminated nonwoven fabric, for example). Polyvinyl chloride, polyethylene or polypropylene, for example, are suitable as the material for the polymer and/or the nonwoven fabric. The polymer or the film may be fabric-reinforced. Very particularly preferably, the textile such as the nonwoven fabric (preferably mainly) contains glass (such as glass fibres), thermoplastic materials, PAN, natural fibres (such as flax or hemp, for example) or mixtures thereof. For example, the exterior layer may comprise a (tubular) film made of polyvinyl chloride having a thickness in a range from 200 to 800 μm. Moreover, the exterior layer may comprise a nonwoven fabric made of polyethylene and/or polypropylene on the inner surface of the polyvinyl chloride film.

The exterior layer may also be fibre-reinforced and in particular reinforced with a fabric. The exterior layer may also comprise several layers made of different materials.

For example, an additional layer made of a thermoplastic polymer such as polypropylene or polyethylene may be provided between the hydrogen barrier layer and the anchor layer. Said layer can be extruded, for example. Preferably, the molecular weight of the material of this layer is lower than the molecular weight of the material of the adjacent layer of the hydrogen barrier layer to enable a high degree of flowability and therefore interlockability. The melt mass flow rate (MFR/190/5, test temperature: 190° C., mass: 5 kg) of the polymer is preferably in a range from 0.2 to 20 g/10 min. The determination can be performed according to DIN EN ISO 1133.

Within the meaning of the invention, “in a non-positive or positive-fit manner” can advantageously mean that the respective layers are lined, laminated, adhesively bonded to one another either over the entire surface or partially. If the layers are partially connected to one another, at least 40% of the layer surfaces are preferably connected to one another or alternatively connected at certain points. Hence, a slippage of the layers against each other can be avoided completely. Additionally or alternatively, the layers may also be connected by extruding a highly flowable thermoplastic material between the layers during manufacture.

Preferably, the hydrogen barrier layer is arranged on that of the two outer surfaces of the liner which is located inside in the rehabilitated hydrogen line.

### Structure of the Fibrous Layer

The fibrous layer may have a thickness in a range from 2 to 120 mm. The upper limit may preferably also be 30 mm. Preferably, the grammage of the at least one fibrous layer may be in a range from 500 to 10,000 g/m², preferably in a range from 600 to 5000 g/m². The fibrous layer is preferably a non-crimp fabric, a mesh, a fabric, a mat, a weft knit fabric, a nonwoven fabric, a felt, a knitted fabric or a combination or a multi-layer structure of these textile fabrics. Thus, the fibrous layers may be mats, for example. These mats may contain a chopping roving. The weight per unit area of the chopping roving in a mat is preferably in a range from 100 to 3000 g/m². The upper limit may preferably also be 1000 g/m². These mats may (also) contain fibres arranged at an angle in a range from −20 degrees to +20 degrees with respect to the longitudinal direction of the liner. The weight per unit area of these fibres in the mat is preferably in a range from 100 to 4000 g/m². The upper limit may preferably also be 500 g/m². These mats may (also) contain fibres arranged at an angle in a range from 45 degrees to 135 degrees with respect to the longitudinal direction of the liner. The weight per unit area of these fibres in the mat is preferably in a range from 100 to 4000 g/m². The upper limit may preferably also be 1000 g/m². The material of the fibres of the fibrous layer is preferably selected from flax, basalt, glass, carbon, aramid, gel-spun polyethylene (Dyneema®, for example), PAN, a thermoplastic polymer or mixtures thereof. Thermoplastic fibres can be made of polypropylene, polyethylene or polyester, for example. The material for the resin of the resin system may be selected from the group of unsaturated polyester resins, silicate resins, vinyl ester resins, epoxy resins or mixtures thereof.

The liner may also contain several fibrous layers, particularly preferably from 2 to 15 fibrous layers. The weight per unit area of all fibrous layers together is preferably in a range from 1000 to 100,000 g/m². The upper limit may preferably also be 5000 g/m².

The fibres may consist of one or several filaments.

The median filament diameter (diameter of the filaments) is preferably in a range from 10 to 300 μm.

At least the fibrous layer is advantageously not wrapped. Preferably, none of the layers is wrapped. At least the fibrous layer is advantageously integral. Within the meaning of the invention, “integral” means that a fibrous layer consists of one and not several mats or material sheets, for example. It is not excluded that the liner has several fibrous layers.

In the impregnated, but not yet cured state the resin in the fibrous layer is preferably not or only partially through-polymerised. The composition of the resin system advantageously contains from 0.1 to 20 parts by weight of a thickener (such as, for example, isocyanate, metal hydroxides, metal oxides such as magnesium oxide, for example, or mineral substances such as kaolin, for example, or mixtures thereof), based on 100 parts by weight of the resin system. It has turned out that this results in a sufficient thickening of the resin composition in the application for rehabilitating lines, however, the resin composition is sufficiently liquid during manufacture to provide a complete impregnation of the anchor layer and the fibrous layer, for example.

The uncured resin preferably contains an initiator for curing by light and/or heat. If the hydrogen barrier layer also contains a metal (preferably in the oxidation state 0, that is, metallic, for example), the resin of the fibrous layer preferably contains an initiator for thermal curing.

### Structure of the Hydrogen Barrier Layer

The liner may contain at least one gas barrier layer and particularly preferably at least one hydrogen barrier layer.

The hydrogen barrier layer is suitable for reducing the diffusion of hydrogen through the hydrogen barrier layer, wherein the hydrogen barrier layer comprises at least one material selected from a polymer, metal, oxide, nitride, carbide and/or mixtures thereof. Preferably, the permeability through the hydrogen barrier layer is in a range from 10⁻⁵ to 10⁻¹¹ cm³ (STP) cm⁻¹s⁻¹bar⁻¹ or alternatively preferably from 10⁻⁵ to 10⁻¹¹ mol H₂ (m·s·MPa)⁻¹ at room temperature and under normal ambient pressure. STP (standard temperature and pressure) represents a temperature of 273.15 K at a pressure of 1 atm. The permeability can be measured according to the description in the article World Electr. Veh. J. 2021, 12, 130.

The hydrogen barrier layer is preferably tubular. Particularly preferably, the hydrogen barrier layer is a film tube. Preferably, a nonwoven fabric can be laminated on one or both sides of the film tube and/or the hydrogen barrier layer. The nonwoven fabric is preferably made of a thermoplastic material (such as polypropylene or polyethylene, for example). The thickness of the nonwoven fabric can be in a range from 10 to 500 μm. This has the advantage that the hydrogen barrier layer can bond particularly well to adjacent layers such as the fibrous layer, for example, during curing of the liner.

The polymer of the hydrogen barrier layer may preferably be selected from the group of polyamide (PA), hard polyethylene (HDPE, high density polyethylene), soft polyethylene (LDPE, low-density polyethylene), LLDPE, liquid crystal polyester resin, bismaleimide resins (graphite fibre-reinforced bismaleimide resin such as Virgin IM7/977-2/AF-191, for example), ethylene-vinyl alcohol resin (EVOH, such as the EVAL Resin of the Kuraray company, for example), fluoroelastomer (VITON A, for example), polytetrafluoroethylene (PTFE), nitrile butadiene resin (BUNA N, for example), ethylene-propylene-diene (monomer) rubber (EPDM, such as silica and/or carbon particle filled EPDM, for example), acrylonitrile styrene acrylate copolymer (ASA), poly(chlorotrifluoroethylene) (CTFE), Noryl, parylene, polybutylene terephthalate (PBT), polycarbonate (PC), polyethylene terephthalate (PET), polyimide (PI), polypropylene (PP), polyphenylene sulfide (PPS), polystyrene (PS), polysulfone (PSU), polyvinyl chloride (PVC), polyvinylfluoride (PVF), Santoprene, UPVC (unplasticised polyvinyl chloride), polyurethane (PU), silicone and/or mixtures thereof. Particularly preferably, the polymer is selected from the group of polyamide, HDPE, LDPE, LLDPE, MDPE, PPS or a mixture thereof. The hydrogen barrier layer can consist of several layers. If the layers are made of different materials, an adhesion promoter can preferably be provided between the layers.

The polymer of the hydrogen barrier layer may also contain from 0.1 to 10% by weight of additives. One additive may be graphene, for example.

The polymer may also be glass fibre-reinforced. The glass fibre content can be in a range from 1 to 20% by weight.

The metal can be steel, iron, aluminum, manganese, zinc, iron, nickel, cobalt, tin, bismuth, copper, silver, palladium, rhodium, platinum, gold, titanium, antimony, tungsten, molybdenum, vanadium, chromium, for example, and is preferably selected from steel, copper, aluminium and/or iron. The aluminium can preferably be oxidised and/or anodised. For example, the metal can be applied as a layer to another layer or sheet by thermal spraying, metal plating, chemical vapor deposition (CVD) or physical vapor deposition (PVD). For example, the metal can be applied to a polymer layer (such as a polymer film) (as described in EP 1 930 363 A2, for example).

The oxide can preferably be selected from aluminium oxide, chromium oxide, erbium oxide, silica and/or mixtures thereof.

The nitride can preferably be selected from boron nitride, titanium nitride, silicon nitride and/or mixtures thereof.

The carbide can preferably be selected from silicon carbide, titanium carbide and/or mixtures thereof.

Preferably, the hydrogen barrier layer comprises a metal layer or consists of a metal.

For example, the hydrogen barrier layer can also comprise a polymer layer made of the above-mentioned preferred polymers and a metal layer (as a film or applied to the polymer layer, for example). These layers can be directly adjacent to one another. Hence, the hydrogen barrier layer can comprise a laminate of a metal foil and a polymer film of the above-mentioned preferred metals and polymers, for example. The hydrogen barrier layer can comprise a laminated film made of at least one metal foil and at least one polymer film, for example.

If the hydrogen barrier foil comprises a metal, the metal may be present as a sheet, a foil or a layer within the hydrogen barrier layer. This sheet, layer or foil can have a thickness in a range from 0.001 to 100 μm, particularly preferably from 5 to 90 μm, for example. For example, the hydrogen barrier layer may comprise a sheet, a foil or a layer made of copper having a thickness in a range from 10 to 90 μm. The hydrogen barrier layer can preferably comprise a metal foil layer or consist of the metal foil.

If the hydrogen barrier foil comprises a polymer, the polymer may be present as a sheet, a foil or a layer within the hydrogen barrier layer. This sheet, layer or foil can have a thickness in a range from 50 to 5000 μm, particularly preferably from 100 to 1000 μm, for example.

Preferably, the polymer is a thermoplastic polymer and particularly not an elastomer. Preferably, the polymer of the hydrogen barrier layer is partially crystalline. Preferably, the degree of crystallisation of the polymer is in a range from 50 to 95%. The degree K of crystallisation of the polymer can be calculated from the ratio of the melting enthalpy measured by DSC to the literature value for 100% crystalline material.

One or several hydrogen barrier layers can be arranged in the liner. If several hydrogen barrier layers are arranged in the liner, they can be the same or different, for example, they may have the same or different materials and/or the same or different thicknesses.

The hydrogen barrier layer advantageously has a thickness in a range from 10 to 1500 μm. In particular, the hydrogen barrier layer has a thickness in a range from 100 to 1000 μm. On the one hand, this allows to protect said hydrogen barrier layer against mechanical damage by the device for curing the liner, for example, on the other hand, it is still thin enough to allow the transmission of heat or UV radiation sufficient for curing. This hydrogen barrier layer advantageously has several layers. One of these layers is a monomer barrier layer, for example. This monomer barrier layer is to prevent the diffusion of reactive diluents such as styrene, for example, from the uncured resin. Advantageously, this monomer barrier layer is one of the layers of the hydrogen barrier layer that is not arranged externally (here, “externally” means “visible for the viewer” and/or “adjacent to the anchor layer”), that is, it is arranged in the core of the hydrogen barrier layer. For example, the monomer barrier layer contains from 10% by weight to 40% by weight or alternatively 100% by weight of a material selected from the group of polyamide, ethylene-vinyl alcohol copolymer, PBT, PET, halogenated polymers or mixtures thereof. As the remainder, the monomer barrier layer preferably contains thermoplastic polymers such as polyethylene or polypropylene, for example. For example, the monomer barrier layer may be a film consisting of several layers. A layer made of polyamide or also a metal (such as copper) may be enclosed by two layers made of a thermoplastic polymer, for example. The monomer barrier layer preferably has a thickness in a range from 5 to 500 μm.

The new inventive monomer barrier layer in the hydrogen barrier layer, which is preferably bonded to the liner in a non-positive or positive fit manner, allows to rehabilitate hydrogen lines by a liner-based rehabilitation process in an environmentally-friendly manner. Moreover, it is possible for the first time to use UV-curable resins and radical initiators.

The hydrogen barrier layer preferably has at least one and advantageously two external layers (here, “external” means “visible for the viewer” and/or “adjacent to the anchor layer”) made of polyurethane, polyethylene or polypropylene. This external layer advantageously has a thickness in a range from 10 to 1000 μm. For example, the external layer adjacent to the anchor layer (when serving as a bonding layer, for example) may be thinner than the other external layer facing the centre of the tube (namely a wear layer, for example). This allows the hydrogen barrier layer to provide an even better protection against mechanical effects.

Preferably, the hydrogen barrier layer is at least partially particle- or fibre-reinforced, particularly preferably carbon fibre-reinforced (with CFRP or graphene, for example) and/or glass fibre-reinforced.

### Exemplary Embodiment

In principle, a conventional liner according to the detailed description in DE102014114746A1 or also in EP2573442A1 was used for manufacturing the inventive impregnated fibre tube (liner) suitable for pull-in. Instead of the 300 μm film described in the exemplary embodiment of EP2573442A1, which was laminated on a polypropylene nonwoven fabric 100 μm thick and consisted of three 100 μm layers of polyethylene, polyamide and polyethylene of equal thickness, another film was used. A laminated film made of a copper foil layer 50 μm thick bonded to two (LDPE) polyethylene layers 100 μm thick on both sides was used. A polypropylene nonwoven fabric 100 μm thick was laminated on this laminated film according to the description in EP2573442A1. The liner was inserted into a suitable tube and cured as usual.

The cured liner was subjected to a test for determining the permeation of hydrogen through the liner. The liner was placed in an autoclave and hydrogen at a pressure of 2 bar was passed through the liner at room temperature. A gas chromatograph was used to detect any hydrogen outside the liner in a nitrogen flow. The detection limit of the gas chromatograph for hydrogen gas was 25 ppmv (parts per million volume). The test was carried out for 50 days and hydrogen could not be detected outside the liner. A hydrogen permeability of <11×10⁻⁷ cm³(STP) cm⁻¹s⁻¹bar⁻¹ was determined at room temperature and normal ambient pressure.

What is claimed is:

1. A method of using a liner for a rehabilitation of a hydrogen line or for a conversion of a line to a transport of hydrogen, wherein the liner comprises at least one fibrous layer impregnated with a resin system.

2. A process for rehabilitating hydrogen lines or converting lines to the transport of hydrogen, wherein a liner is inserted into a line and then cured, wherein the liner comprises at least one fibrous layer impregnated with a resin system.

3. The process according to claim 2, wherein the liner comprises a hydrogen barrier layer, wherein the hydrogen barrier layer comprises at least one material selected from the group consisting of a polymer, metal, oxide, nitride, carbide, graphene, and a mixture thereof.

4. The process according to claim 3, wherein the hydrogen barrier layer comprises a metal layer or consists of a metal.

5. The process according to claim 3, wherein the polymer is a polyamide, HDPE, LDPE, LLDPE, MDPE, PPS, or a mixture thereof.

6. The process according to claim 3, wherein the hydrogen barrier layer is reinforced with fibres or particles.

7. The process according to claim 2, wherein a ratio of a diameter to a wall thickness of the cured liner is in a range from 25 to 200.

8. The process according to claim 2, wherein the liner is a pull-in liner.

9. The process according to claim 2, wherein the fibres consist of one or several filaments and a median diameter of the filaments is in a range from 10 to 300 μm.

10. The process according to claim 2, wherein the line is operated with a pressure exceeding 1 bar.

11. The method according to claim 1, wherein the liner is inserted into the line and then cured.

12. The method according to claim 1, wherein the liner comprises a hydrogen barrier layer, wherein the hydrogen barrier layer comprises at least one material selected from a polymer, metal, oxide, nitride, carbide, graphene, and a mixture thereof.

13. The method according to claim 12, wherein the hydrogen barrier layer comprises a metal layer or consists of a metal.

14. The method according to claim 12, wherein the polymer is a polyamide, HDPE, LDPE, LLDPE, MDPE, PPS, or a mixture thereof.

15. The method according to claim 12, wherein the hydrogen barrier layer is reinforced with fibres or particles.

16. The method according to claim 11, wherein a ratio of a diameter to a wall thickness of the cured liner is in a range from 25 to 200.

17. The method according to claim 1, wherein the liner is a pull-in liner.

18. The method according to claim 1, wherein the fibres consist of one or several filaments and a median diameter of the filaments is in a range from 10 to 300 μm.

19. The method according to claim 1, wherein the line is operated with a pressure exceeding 1 bar.
